(19) United States
(12) Patent Application Publication
(10) Pub. No.: US 2017/0021432 A1
(43) Pub. Date: Jan. 26, 2017

(54) FIRMLY ASSEMBLED HIGH-PRECISION CUTTER HOLDER

(71) Applicant: Ching-Ting CHEN, Taichung City (TW)

(72) Inventor: Ching-Ting CHEN, Taichung City (TW)

(21) Appl. No.: 14/807,066

(22) Filed: Jul. 23, 2015

(51) Int. Cl. B23B 31/20

(52) U.S. Cl. CPC B23B 31/20; B23B 2231/201; B23B 2231/2008

(57) ABSTRACT

A cutter holder includes a body, a collet, a cutter, and a fastening cap. The cutter is inserted into the collet. The collet is assembled on the body with the cutter. The fastening cap is mounted on the body, and the cutter protrudes from the fastening cap. The body has a fastening portion; the collet has an annular groove. The fastening portion has a fastening portion end face. The annular groove has a first face. The fastening portion end face and the first face are separated by a distance. By means of confining the distance between the fastening portion end face and the first face, a contact area between the body and the collet is increased to enhance the clamping force. Accordingly, the cutter holder can firmly clamp the collet for precise machining.

### FIELD

The present invention relates to a machine tool, and more particularly to a high-precision cutter holder that can hold a cutter firmly.

### BACKGROUND

This section provides background information related to the present disclosure which is not necessarily prior art.

With the reference to FIG. 4, a conventional cutter holder comprises a body 60, a collet 70, a cutter 80, and a fastening cap 90. The cutter 80 is inserted into the collet 70, and the collet 70 and the cutter 80 are assembled on the body 60. The fastening cap 90 has an inner thread and is mounted on the body 60 to allow the cutter 80 to protrude from the fastening cap 90.

The body 60 has two ends, a fastening portion 61, and an inner socket 62. The fastening portion 61 is disposed at one of the ends and is provided with an external thread 611 and a fastening portion end face 612. The inner socket 62 and the fastening portion 61 are arranged at the same end of the body 60, the inner socket 62 is a tapered hole which extends from one of the ends of the body 60 to the other end. The collet 70 has two ends, a conjoint portion 71, a fastening cap abutting portion 72, and an annular groove 73. The conjoint portion 71 is cone-shaped, corresponds to the inner socket 62 in sectional shape, and is disposed at one of the ends of the collet 70. The fastening cap abutting portion 72 is disposed at the other end of the collet 70. The annular groove 73 is disposed between the conjoint portion 71 and the fastening cap abutting portion 72. The annular groove 73 has a first face 731 and a second face 732, and the first face 731 and the second face 732 are parallel in radial direction. The annular groove 73 has two sides. The first face 731 is located at the side of the annular groove 73 which is adjacent to the conjoint portion 71. The second face 732 is located at the other side of the annular groove 73 which is adjacent to the fastening cap abutting portion 72.

A contact area is defined between the inner socket 62 of the body 60 and the conjoint portion 71 of the collet 70. Since the contact area is small, the collet 70 protrudes from the body 60 at a large distance. The fastening portion end face 612 and the first face 731 of the collet 70 are separated by a distance W1 between 3.5 millimeters (mm) and 3.7 mm. With the small contact area, the force for the body 60 clamping the collet 70 is weak and the cutter 80 is deflected easily. Moreover, the body 60 and the fastening cap 90 of the conventional cutter holder are connected by screwing and a gap is formed between the external thread 611 of the fastening portion 61 and the inner thread 91 of the fastening cap 90. When the conventional cutter holder spins rapidly, the gap causes vibration easily, and the body 60 fails to abut against the collet 70. The problems mentioned above cause poor balance of the conventional cutter holder and reduce machining accuracy.

To overcome the shortcomings of the conventional cutter holder, the present invention provides a firmly assembled high-precision cutter holder to mitigate or obviate the aforementioned problems.

### SUMMARY

This section provides a general summary of the disclosure, and is not a comprehensive disclosure of its full scope or all of its features.

An aspect of the present invention is to provide a firmly assembled high-precision cutter holder that can perform machining precisely during rapid spinning.

The cutter holder comprises a body, a collet, a cutter, and a fastening cap. The cutter is inserted into the collet. The collet is assembled on the body with the cutter. The fastening cap is mounted on the body. The cutter protrudes from the fastening cap. The body has a fastening portion. The collet has an annular groove. The fastening portion has a fastening portion end face. The annular groove has a first face. The fastening portion end face and the first face are separated by a distance. By means of confining the distance between the fastening portion end face and the first face to increase a contact area between the body and the collet, insufficient clamping force of the conventional cutter holder can be resolved. The present invention provides a firmly assembled high-precision cutter holder that can steadily clamp the collet for precise machining.

Other aspects, advantages, and novel features of the invention will become more apparent from the following detailed description when taken in conjunction with the accompanying drawings.

### DRAWINGS

The drawings described herein are for illustrative purposes only of a selected embodiment and not all possible implementations, and are not intended to limit the scope of the present disclosure.

FIG. 1 is a perspective view of a firmly assembled high-precision cutter holder in accordance with the present invention;

FIG. 2 is an exploded perspective view of the firmly assembled high-precision cutter holder in FIG. 1;

FIG. 3 is a side view in partial section of the firmly assembled high-precision cutter holder in FIG. 1; and

FIG. 4 is a side view in partial section of a conventional cutter holder.

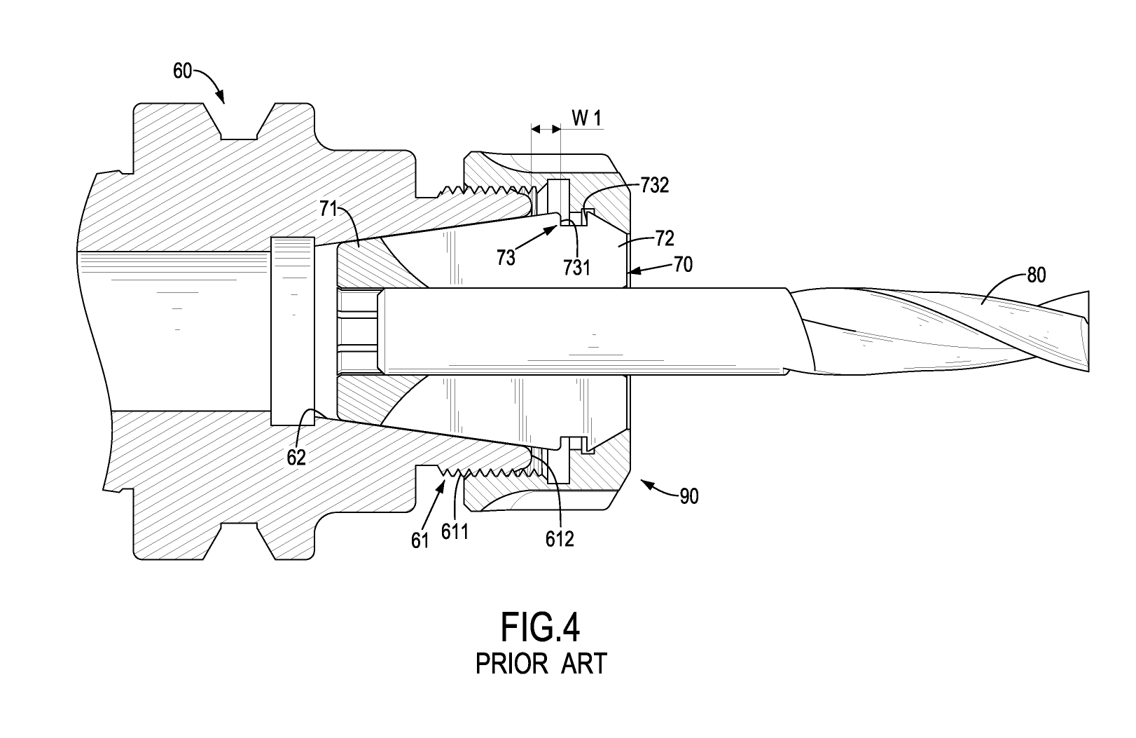

### DETAILED DESCRIPTION

An example embodiment will now be described more fully with reference to the accompanying drawings

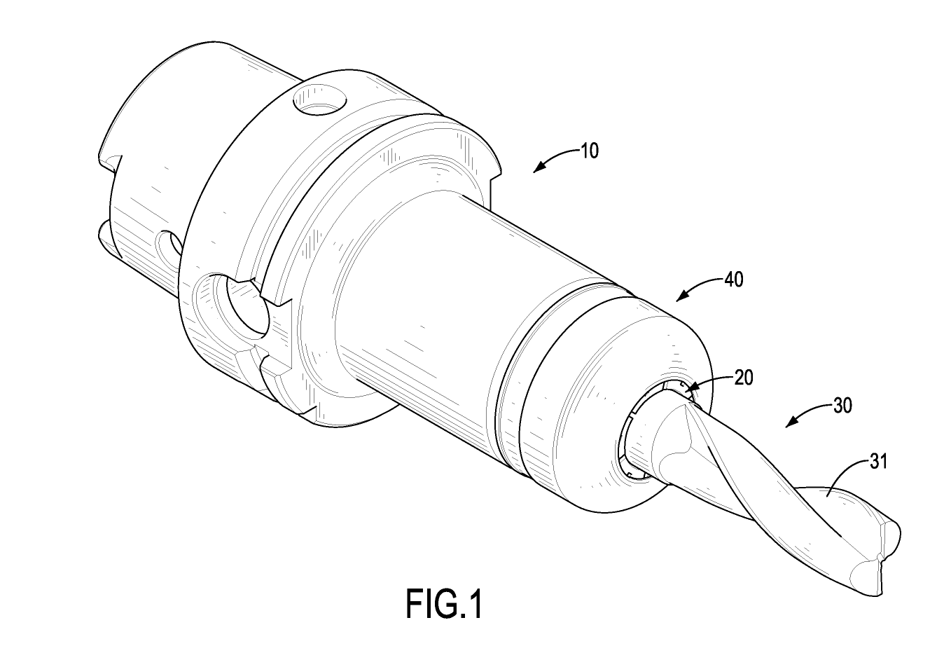

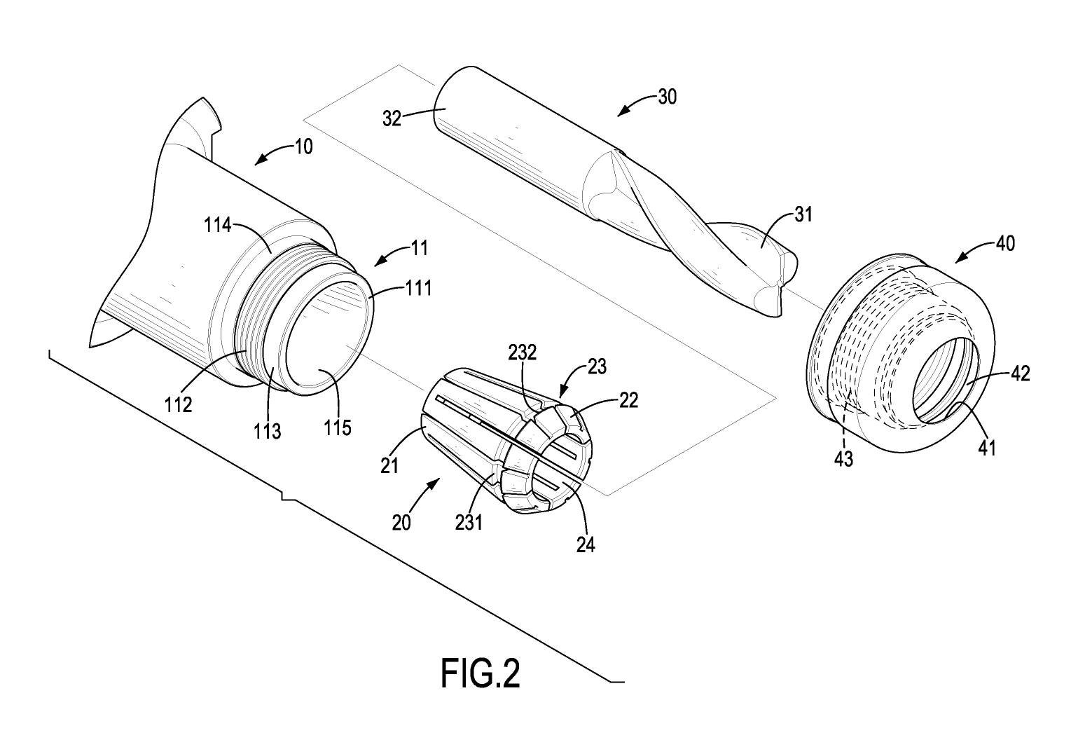

With reference to FIG. 1 and FIG. 2, a firmly assembled high-precision cutter holder in accordance with the present invention comprises a body 10, a collet 20, a cutter 30, and a fastening cap 40. The cutter 30 is inserted in the collet 20. The collet 20 and the cutter 30 are assembled on the body 10. The fastening cap 40 is mounted on the body 10. The cutter 30 protrudes from the fastening cap 40.

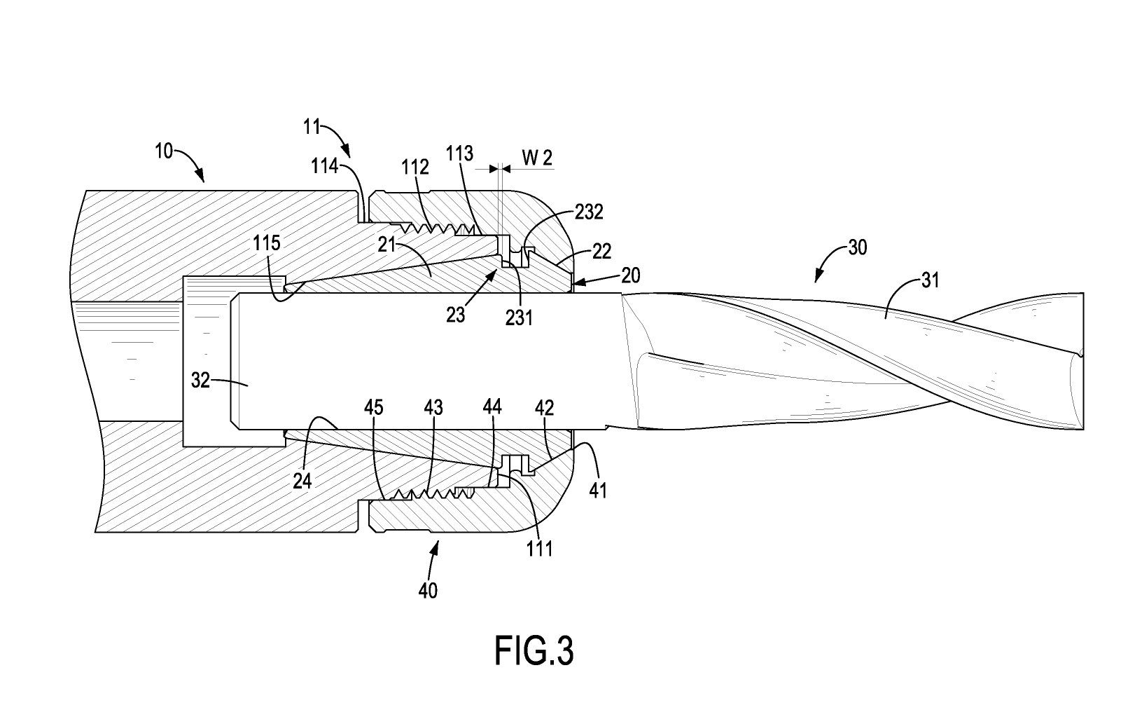

With reference to FIG. 2 and FIG. 3, the body 10 has two ends and a fastening portion 11 which defines a fastening portion end face 111 formed at one of the two ends of the body 10. The fastening portion 11 has a first threaded portion 112, a first abutting face 113, a second abutting face 114, and an inner socket 115. The fastening portion 11 has an outer surface. The first threaded portion 112 has an external thread formed on the outer surface of the fastening portion 11 and adjacent to the fastening portion end face 111. The first threaded portion 112 has two sides. The first abutting face 113 and the second abutting face 114 are disposed respectively at the two sides of the first threaded portion 112. The first abutting face 113 is adjacent to the fastening portion end face 111. The first abutting face 113 and the second abutting face 114 each have an outer diameter respectively. The outer diameter of the first abutting face 113 is smaller than the outer diameter of the second abutting face 114. The inner socket 115 is a tapered hole which extends from the fastening portion end face 111 toward the other end of the body 10.

With reference to FIG. 2 and FIG. 3, the collet 20 has two ends, a conjoint portion 21, a fastening cap abutting portion 22, an annular groove 23, and a central hole 24. The conjoint portion 21 is cone-shaped and corresponds to the inner socket 115 in sectional shape. The conjoint portion 21 is disposed at one of the two ends of the collet 20. The fastening cap abutting portion 22 is annular, has an inclined abutting face, and is located at the other end of the collet 20. The annular groove 23 is formed between the conjoint portion 21 and the fastening cap abutting portion 22. The annular groove 23 is provided with a first face 231 and a second face 232. The first face 231 and the second face 232 are parallel to each other in a radial direction. The annular groove 23 has two sides. The first face 231 is located at the side of the annular groove 23 that is adjacent to the conjoint portion 21. The second face 232 is located at the other side of the annular groove 23 that is adjacent to the fastening cap abutting portion 22. The central hole 24 is defined axially through the collet 20 from the conjoint portion 21 to the fastening cap abutting portion 22 and has an inner diameter.

With reference to FIG. 2 and FIG. 3, the cutter 30 has two ends, a cutting portion 31, and a collet assembling portion 32. The cutting portion 31 is located at one of the two ends of the cutter 30. The collet assembling portion 32 is located at the other end of the cutter 30 and has an outer diameter. The outer diameter of the collet assembling portion 32 is substantially equal to the inner diameter of the central hole 24 of the collet 20.

With reference to FIG. 2 and FIG. 3, the fastening cap 40 has a cap plate and a side wall connected with the cap plate. The side wall of the fastening cap 40 has an inner surface. The fastening cap 40 has a through hole 41, a collet abutting portion 42, a second threaded portion 43, a first abutting portion 44, and a second abutting portion 45. The through hole 41 is defined through the middle part of the cap plate and has an inner surface. The collet abutting portion 42 is formed on the inner surface of the through hole 41. The collet abutting portion 42 is annular and has an inclined face which abuts against the fastening cap abutting portion 22. The second threaded portion 43, the first abutting portion 44, and the second abutting portion 45 are disposed on the inner surface of the side wall of the fastening cap 40. The second threaded portion 43 has an inner thread engaging with the external thread of the first threaded portion 112. The second threaded portion 43 has two sides. The first abutting portion 44 and the second abutting portion 45 are disposed at the two sides of the second threaded portion 43 respectively. The first abutting portion 44 is adjacent to the collet abutting portion 42 and abuts the first abutting face 113 of the body 10. The second abutting portion 45 abuts the second abutting face 114 of the body 10. The first abutting portion 44 and the second abutting portion 45 each have an inner diameter respectively. The inner diameter of the first abutting portion 44 is smaller than the inner diameter of the second abutting portion 45.

With reference to FIG. 2 and FIG. 3, to assemble the cutter holder of the present invention, the collet assembling portion 32 of the cutter 30 is inserted into the central hole 24 of the collet 20. Secondly, the collet 20 and the cutter 30 are assembled on the body 10 with the conjoint portion 21 of the collet 20 fitting and abutting the inner socket 115 of the body 10. Lastly, the fastening cap 40 is screwed with the body 10 by the second threaded portion 43 and the first threaded portion 112 to make the collet abutting portion 42 of the fastening cap 40 abut against the fastening cap abutting portion 22 of the collet 20. Accordingly, the cutting portion 31 of the cutter 30 is allowed to protrude from the through hole 41 of the fastening cap 40.

The fastening portion end face 111 of the body 10 and the first face 231 of the collet 20 are separated by a distance W2. The present invention confines the distance W2 between 0.1 mm and 0.6 mm. Compared with the conventional cutter holder, the distance W2 is smaller than the distance W1 of the conventional cutter holder. The smaller distance W2 can increase the contact area between the inner socket 115 of the body 10 and the conjoint portion 21 of the collet 20. The larger contact area between the inner socket 115 and the conjoint portion 21 can increase the clamping intensity, which can thereby resolve the conventional cutter holder's drawback that vibrations are generated easily. The first abutting portion 44 and the second abutting portion 45 of the fastening cap 40 abut against the first abutting face 113 and the second abutting face 114 of the body 10 respectively, thereby reducing generation of vibrations while the cutter holder spins rapidly.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “includes,” “including,” “having,” “has”, and “have,” are inclusive and therefore specify the presence of stated features, elements, and/or components, but do not preclude the presence or addition of one or more other features, elements, components, and/or groups thereof.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cutter holder comprising:
a body having:
two ends; and
a fastening portion including a fastening portion end face formed at one of the two ends of the body; and
an inner socket;
a collet connected with the body, the collet having:
two ends;
a conjoint portion corresponding to the inner socket in sectional shape and disposed at one of the two ends of the collet, and the conjoint portion fitting and abutting against the inner socket;
an annular groove being adjacent to the conjoint portion, the annular groove having:
two sides;
a first face being parallel to a radial direction of the annular groove and located at one of the two sides of the annular groove that is adjacent to the conjoint portion, and the first face and the fastening end portion face separated by a distance between 0.1 millimeters and 0.6 millimeters; and
a central hole defined axially through the collet from the conjoint portion and having an inner diameter; and
a cutter having a collet assembling portion inserted into the central hole, the collet assembling portion having an outer diameter being substantially equal to the inner diameter of the central hole; and
a fastening cap connected with the fastening portion.

2. The cutter holder as claimed in claim 1:
wherein the fastening portion includes:
an outer surface;
a first threaded portion having two sides and an external thread formed on the outer surface of the fastening portion and being adjacent to the fastening portion end face; and
a first abutting face disposed on the outer surface of the fastening portion, the first abutting face being at one of the two sides of the first threaded portion and adjacent to the fastening portion end face; and
wherein the fastening cap includes:
a side wall having an inner surface;
a second threaded portion disposed on the inner surface of the side wall, the second threaded portion having two sides and an inner thread engaged with the external thread of the first threaded portion; and
a first abutting portion disposed on the inner surface of the side wall of the fastening cap, the first abutting portion disposed at one of the sides of the second threaded portion and adjacent to the second threaded portion, and the first abutting portion abutting against the first abutting face.

3. The cutter holder as claimed in claim 2, wherein:
the fastening portion includes a second abutting face disposed on the outer surface of the fastening portion, the second abutting face disposed at one of the sides of the first threaded portion and adjacent to the first threaded portion; and
the fastening cap includes a second abutting portion disposed on the inner surface of the side wall of the fastening cap, and the second abutting portion and the first abutting portion disposed respectively at the two sides of the second threaded portion, and the second abutting portion abutting against the second abutting face.

4. The cutter holder as claimed in claim 3, wherein:
the first abutting face has an outer diameter;
the second abutting face has an outer diameter larger than the outer diameter of the first abutting face;
the first abutting portion has an inner diameter; and
the second abutting portion has an inner diameter larger than the outer diameter of the first abutting portion.
